(19) United States
(12) Patent Application Publication
(10) Pub. No.: US 2006/0029154 A1
(43) Pub. Date: Feb. 9, 2006

(54) Distortion compensation device and distortion compensation method

(75) Inventors: Hideo Nagata, Ogasa-gun (JP); Takashi Enoki, Yokohama-shi (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 10/537,799

(22) PCT Filed: Dec. 16, 2003
(86) PCT No.: PCT/JP03/16071

§ 371 Date: Jun. 7, 2005

(30) Foreign Application Priority Data
Dec. 17, 2002 (JP) 2002-365447

(51) Int. Cl. H04L 25/03

(52) U.S. Cl. 375/296

(57) ABSTRACT

A compensation data table 304 generates baseband signal nonlinear characteristic information. A determination section 305 determines from measured power whether power is on an upward trend or on a downward trend. An IM unbalance compensation computation section 306 generates an unbalance IM characteristic so that an amplitude component and phase component when power is identical differ when power is on an upward trend and when power is on a downward trend, and generates a compensation signal of a compensation characteristic that has an amplitude component and phase component that are symmetrical with the generated unbalance IM characteristic with respect to amplitude component and phase component fixed values when there is a linear characteristic. A complex multiplication section 307 combines the baseband signal with the compensation signal. An amplifier 312 amplifies the baseband signal and also suppresses distortion components generated during amplification by means of the compensation signal. By this means, distortion components in a state of lower/upper unbalance can be suppressed with high precision.

### TECHNICAL FIELD

The present invention relates to a distortion compensation apparatus and distortion compensation method, and, for example, to a distortion compensation apparatus and distortion compensation method that eliminate distortion generated when a signal is amplified.

### BACKGROUND ART

Heretofore a predistortion distortion compensation apparatus has been known as an apparatus that compensates for distortion generated when a transmit signal is amplified in a radio communication apparatus. FIG. 1 is a block diagram showing the configuration of a conventional predistortion distortion compensation apparatus 100.

Conventional predistortion distortion compensation apparatus 100 is composed of a baseband I input terminal 101, a baseband Q input terminal 102, a power calculation section 103, a compensation data table 104, a complex multiplication section 105, a digital/analog converter (hereinafter referred to as “DAC”) 106, a DAC 107, a modulator (hereinafter referred to as “MOD”) 108, an oscillator 109, a power amplifier 110, and an RF output terminal 111.

In FIG. 1, a baseband I signal is input to baseband I input terminal 101 and a baseband Q signal orthogonal to the I signal is input to baseband Q input terminal 102, and these signals pass through DAC 106 and DAC 107, and are modulated to RF signals by despreading section 108. The signal modulated to RF then undergoes power amplification by power amplifier 110 and is output from RF output terminal 111.

At this time, since power amplifier 110 performs nonlinear operation, distortion is generated in the signal amplified by power amplifier 110. A predistortion function is a function for amending the nonlinearity of power amplifier 110 to linearity. In order to perform power amplifier 110 linearity compensation, compensation data table 104 is provided with compensation data corresponding to power values. Power calculation section 103 performs input baseband signal power calculation every sampling time and outputs the result to compensation data table 104. Compensation data table 104 is referenced using the power calculation result input from power calculation section 103, and the necessary compensation data is extracted and output to complex multiplication section 105. Complex multiplication section 105 operates so as to suppress distortion generated in power amplifier 110 for the input I signal and Q signal.

Due to various factors such as temperature characteristics, the nonlinearity of power amplifier 110 differs even if the measured power is the same when the measured power is on an upward trend and when the measured power is on a downward trend.

FIG. 2 is a drawing showing signal components and distortion components on the frequency axis when a transmit signal is amplified. As shown in FIG. 2, when a transmit signal is composed of two waves, a signal component #201 of frequency f1 and a signal component #202 of frequency f2 (where f1<f2), a lower-side (low-frequency side) distortion component #203 and upper-side (high-frequency side) distortion component #204 are generated by amplifying the transmit signal. In this case, distortion component #203 level β is greater than distortion component #204 level α, and lower/upper unbalance occurs in which the levels of the low-frequency-side distortion component and high-frequency-side distortion component on the frequency axis generated in the signal amplified by power amplifier 110 are different.

However, a problem with a conventional distortion compensation apparatus and distortion compensation method is that the correspondence between power and compensation data is set in compensation data table 104 without taking lower/upper unbalance into consideration, and consequently distortion component #203 and distortion component #204 in a state of lower/upper unbalance cannot be suppressed with high precision.

### DISCLOSURE OF INVENTION

It is an object of the present invention to provide a distortion compensation apparatus and distortion compensation method that enable distortion components in a state of lower/upper unbalance to be suppressed with high precision.

This object can be achieved by generating a compensation signal for suppressing baseband signal distortion components so that the phase component and amplitude component when power is the same in that compensation signal differs when the currently measured power in the baseband signal is rising with respect to power measured in the past and when the currently measured power in the baseband signal is falling with respect to power measured in the past.

### BRIEF DESCRIPTION OF DRAWINGS

FIG. 1 is a block diagram showing the configuration of a conventional predistortion distortion compensation apparatus;

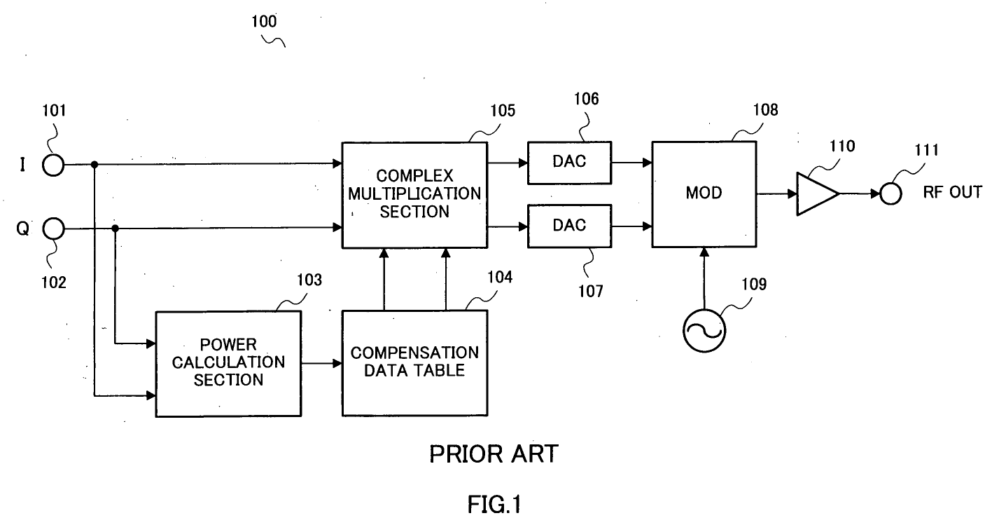

FIG. 2 is a drawing showing conventional signal components and distortion components;

FIG. 3 is a block diagram showing the configuration of a transmitting apparatus according to an embodiment of the present invention;

FIG. 4 is a drawing showing the nonlinear relationship between power and amplitude when there is no hysteresis in a power amplifier according to an embodiment of the present invention;

FIG. 5 is a drawing showing the nonlinear relationship between power and phase when there is no hysteresis in a power amplifier according to an embodiment of the present invention;

FIG. 6 is a drawing showing the relationship between power and amplitude when there is hysteresis in a power amplifier according to an embodiment of the present invention;

FIG. 7 is a drawing showing the relationship between power and phase when there is hysteresis in a power amplifier according to an embodiment of the present invention;

FIG. 8 is a drawing showing the relationship between power and amplitude in a compensation signal according to an embodiment of the present invention;

FIG. 9 is a drawing showing the relationship between power and phase in a compensation signal according to an embodiment of the present invention;

FIG. 10 is a drawing showing the relationship between power and amplitude in a compensation signal according to an embodiment of the present invention; and

FIG. 11 is a drawing showing the relationship between power and phase in a compensation signal according to an embodiment of the present invention.

### BEST MODE FOR CARRYING OUT THE INVENTION

With reference now to the accompanying drawings, an embodiment of the present invention will be explained in detail below.

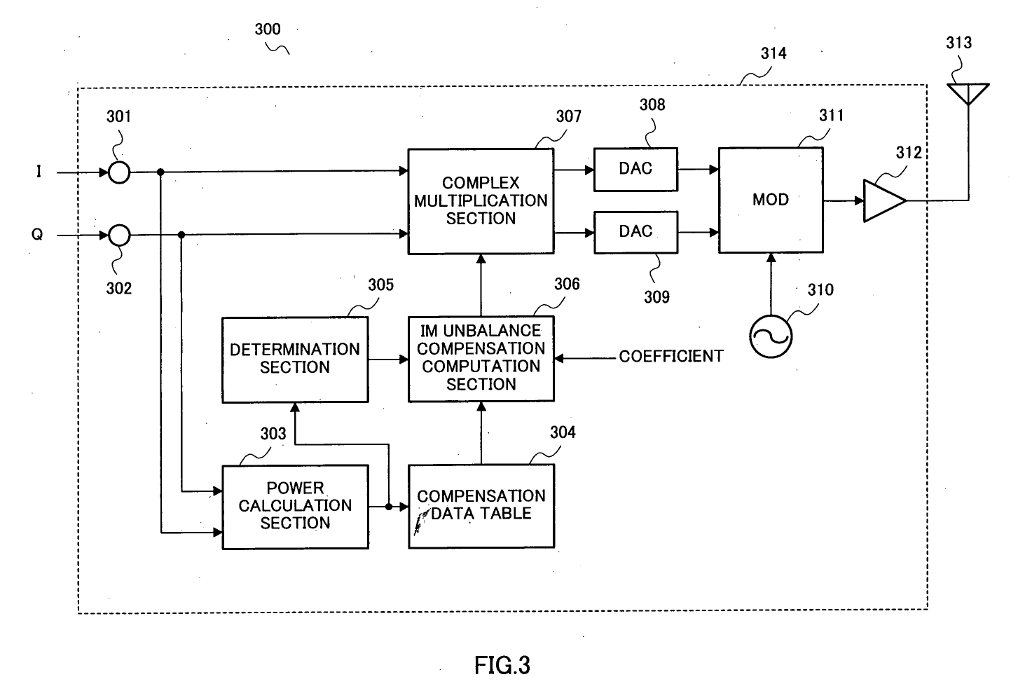

FIG. 3 is a block diagram showing the configuration of a transmitting apparatus 300 according to an embodiment of the present invention. In FIG. 3, transmitting apparatus 300 is mainly composed of an input terminal 301, an input terminal 302, a power calculation section 303, a compensation data table 304, a determination section 305, an IM unbalance compensation computation section 306, a complex multiplication section 307, a DAC 308, a DAC 309, an oscillator 310, a MOD 311, an amplifier 312, and an antenna 313.

Input terminal 301, input terminal 302, power calculation section 303, compensation data table 304, determination section 305, IM unbalance compensation computation section 306, complex multiplication section 307, DAC 308, DAC 309, oscillator 310, MOD 311, and amplifier 312 make up a distortion compensation apparatus 314. For distortion compensation apparatus 314 in FIG. 3, a predistortion distortion compensation apparatus configuration is shown, with power calculation section 303, compensation data table 304, determination section 305, IM unbalance compensation computation section 306, and complex multiplication section 307 forming a predistortion function.

Input terminal 301 receives an I component baseband signal and sends this signal to power calculation section 303 and complex multiplication section 307.

Input terminal 302 receives a Q component baseband signal and sends this signal to power calculation section 303 and complex multiplication section 307.

Power calculation section 303 performs power calculations for baseband signals input from input terminal 301 and input terminal 302 every sampling time, and outputs measured power information, which is calculated power information, to compensation data table 304 and determination section 305.

Compensation data table 304 vector information comprises a data table of amplifier 312 that has nonlinear characteristics. Then compensation data table 304 outputs amplifier 312 nonlinear characteristic information to IM unbalance compensation computation section 306 based on measured power information input from power calculation section 303 and the data table in compensation data table 304. Nonlinear characteristic information held by compensation data table 304 as vector information is the same as nonlinear characteristic information held by data table 104 as vector information.

Using at least two items of measured power information in the measured power information for each sampling time input from power calculation section 303, determination section 305 determines whether measured power according to the latest measured power information is rising or falling in comparison with measured power according to past measured power information, and outputs the determination result to IM unbalance compensation computation section 306.

IM unbalance compensation computation section 306, which is the compensation computation section, generates a compensation signal based on nonlinear characteristic information found at at least two different times input from compensation data table 304, a coefficient, the result of determination by determination section 305 as to whether measured power is on an upward trend or on a downward trend, and a fixed value when amplifier 312 is assumed to have a linear characteristic—that is, when the amplifier performs fixed transmission operation regardless of input power. IM unbalance compensation computation section 306 then outputs the generated compensation signal to complex multiplication section 307. The method of determining the compensation signal will be described later herein.

Complex multiplication section 307, which is the compensation signal combining section, suppresses baseband signal distortion components based on the baseband signals input from input terminal 301 and input terminal 302 and the compensation signal input from IM unbalance compensation computation section 306, and outputs the resulting signals to DAC 308 and DAC 309.

DAC 308 converts the baseband signal input from complex multiplication section 307 from analog data to digital data, and outputs this digital data to MOD 311.

DAC 309 converts the baseband signal input from complex multiplication section 307 from analog data format to digital data format and generates a digital converted signal, and outputs this signal to MOD 311.

Oscillator 310 is a local oscillator that outputs a predetermined frequency signal to MOD 311.

MOD 311 modulates digital converted signals input from DAC 308 and DAC 309 using a signal input from oscillator 310 and generates a modulated signal, and outputs this modulated signal to amplifier 312.

Amplifier 312 amplifies the modulated signal input from MOD 311 and sends the amplified signal to antenna 313.

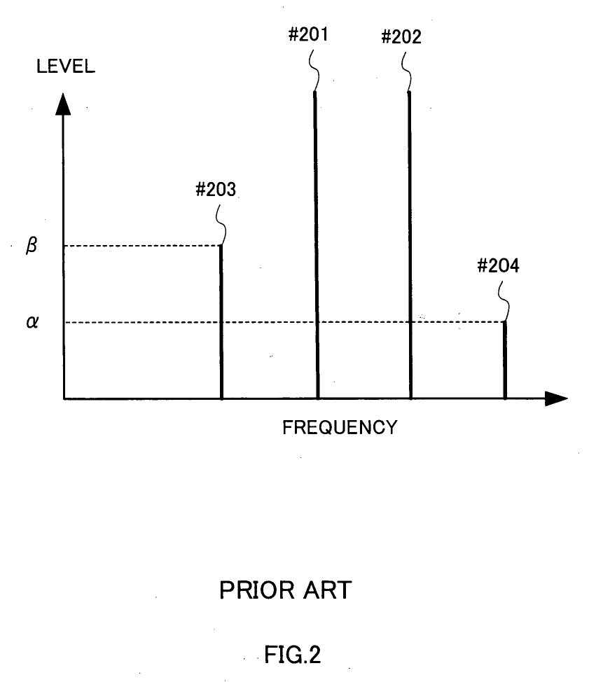

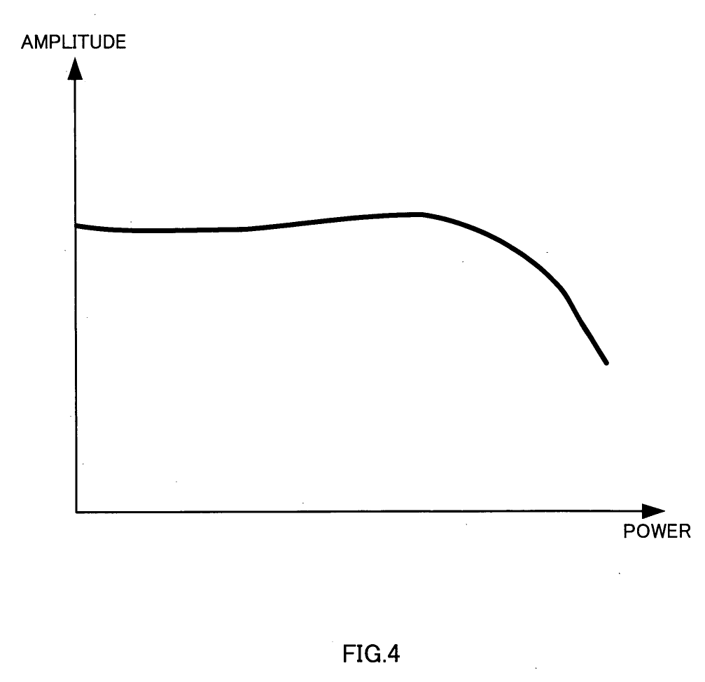

Next, the operation of transmitting apparatus 300 when distortion component #203 and distortion component #204 shown in FIG. 2 are suppressed will be described using FIG. 4 through FIG. 11.

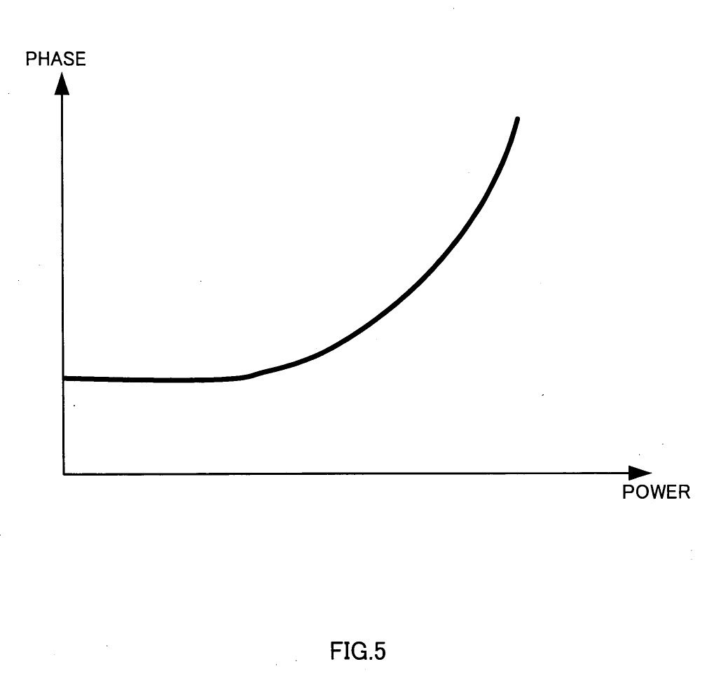

A baseband signal is input to power calculation section 303 and complex multiplication section 307 as orthogonal data composed of an I component and a Q component. Power calculation section 303 calculates power from the input baseband signals. Then compensation data table 304 outputs amplifier 312 nonlinear characteristic information to IM unbalance compensation computation section 306. At this time, the relationship between amplitude and power shown in FIG. 4 is stored in compensation data table 304. In addition, the relationship between phase and power shown in FIG. 5 is stored in compensation data table 304.

IM unbalance compensation computation section 306 has a function of performing computational processing of input amplifier 312 nonlinear characteristic information so as to show the actual unbalance IM characteristic, and a function of converting from the obtained unbalance IM characteristic to a compensation characteristic for linear output by amplifier 312 and generating a compensation signal.

When performing computational processing to show the unbalance IM characteristic, IM unbalance compensation computation section 306 finds the unbalance IM characteristic based on information on the nonlinear characteristic at time t-1 input from compensation data table 304, information on the nonlinear characteristic at time t after the elapse of a predetermined time from time t−1 input from compensation data table 304, a coefficient, the result of determination by determination section 305 as to whether measured power is on an upward trend or on a downward trend, and a fixed value.

Specifically, the unbalance IM characteristic can be found using Equation (1) or Equation (2).
Real_{—}amp(t)=amp(t)+(amp(t)−amp(t−1))×(Li_{—}amp−amp(t−1))×g (1)
Real_{—}amp(t)=amp(t)−(amp(t)−amp(t−1))×(Li_{—}amp−amp(t−1))×g (2)
where
Real_amp(t): Unbalance IM characteristic at time t
amp(t): Nonlinear characteristic at time t
amp(t−1): Nonlinear characteristic at time t−1
Li_amp: Fixed value
g: Coefficient

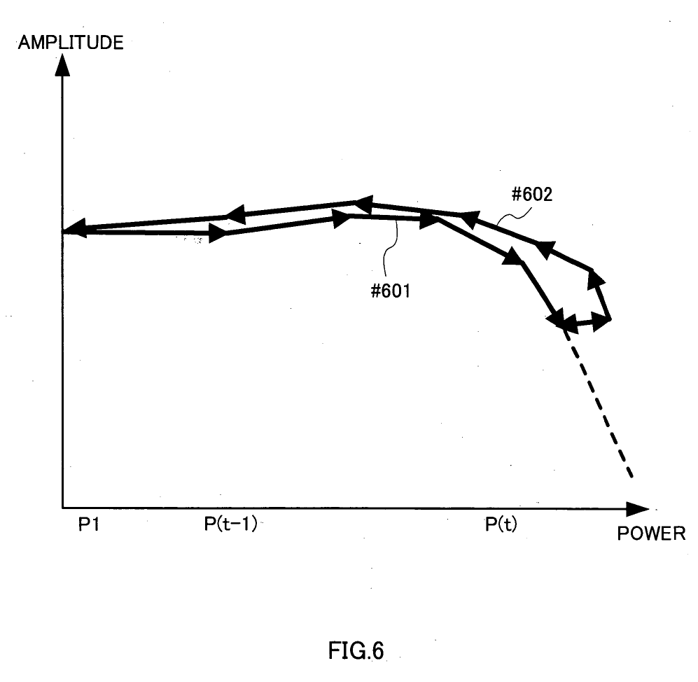

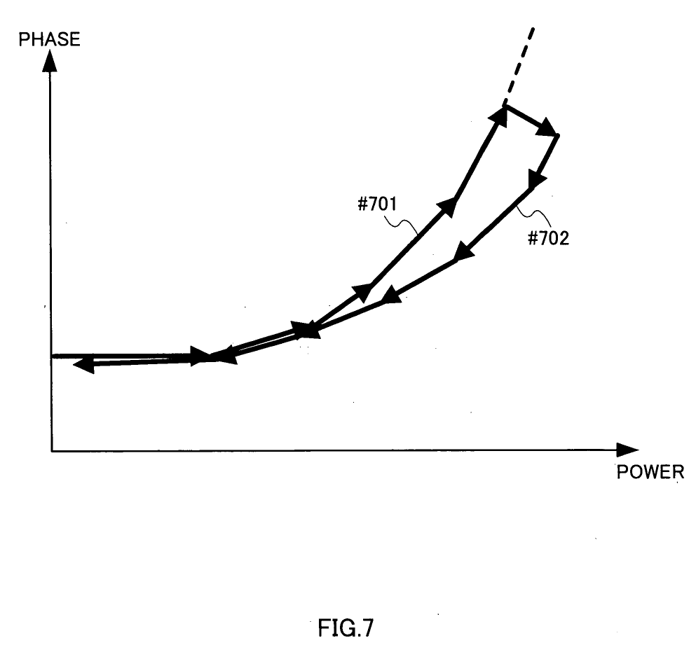

In this way, IM unbalance compensation computation section 306 finds the unbalance IM characteristic shown in FIG. 6 from the amplifier 312 nonlinear characteristic shown in FIG. 4, and also finds the unbalance IM characteristic shown in FIG. 7 from the amplifier 312 nonlinear characteristic shown in FIG. 5. As shown in FIG. 6, the relationship between amplitude and power in the unbalance IM characteristic has hysteresis whereby the relationship #601 between power and amplitude when power is on an upward trend and the relationship #602 between power and amplitude when power is on a downward trend follow different paths. Also, as shown in FIG. 7, the relationship between phase and power in the unbalance IM characteristic has hysteresis whereby the relationship #701 between power and phase when power is on an upward trend and the relationship #702 between power and phase when power is on a downward trend follow different paths. The relationship between power and amplitude and the relationship between power and phase when there is hysteresis of this kind can be changed by setting coefficient g in Equation (1) and Equation (2) variably.

Next, when IM unbalance compensation computation section 306 converts an unbalance IM characteristic to a compensation characteristic and generates a compensation signal, IM unbalance compensation computation section 306 performs conversion to a compensation characteristic so that there is symmetry with the unbalance IM characteristic with respect to a fixed value at which amplitude and phase become almost fixed when amplifier 312 is assumed to have a linear characteristic. Specifically, the compensation characteristic is obtained from Equation (3) using the unbalance IM characteristic and linear characteristic found from Equation (1) or Equation (2).
Compensation characteristic=Li_{—}amp/Real_{—}amp (3)
where
Real_amp(t): Unbalance IM characteristic at time t
Li_amp: Fixed value

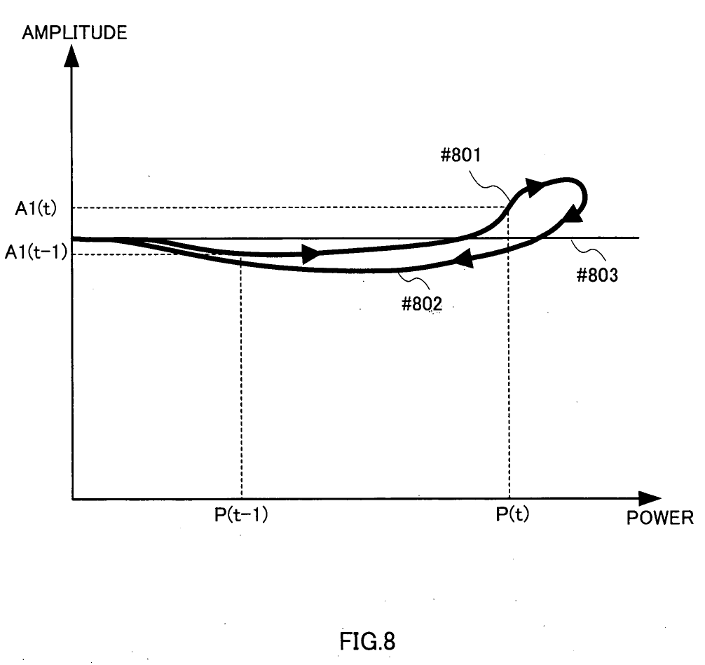

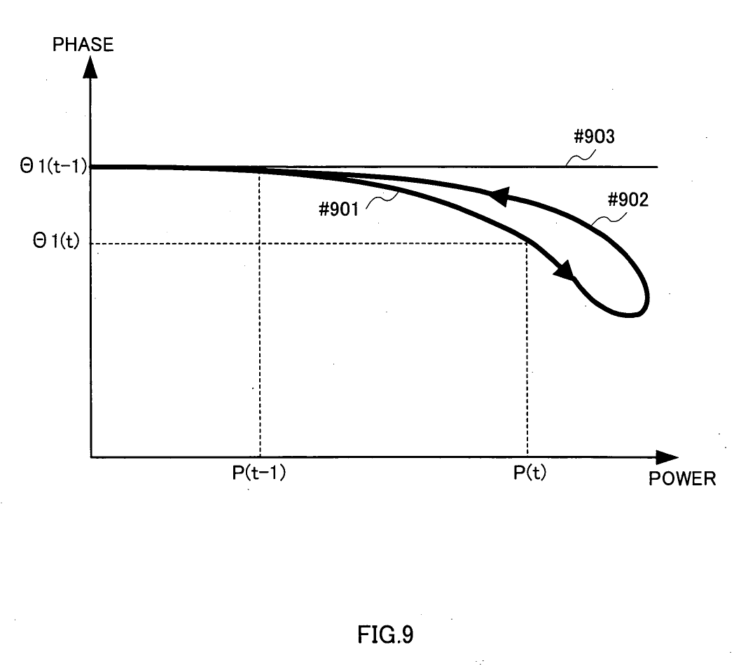

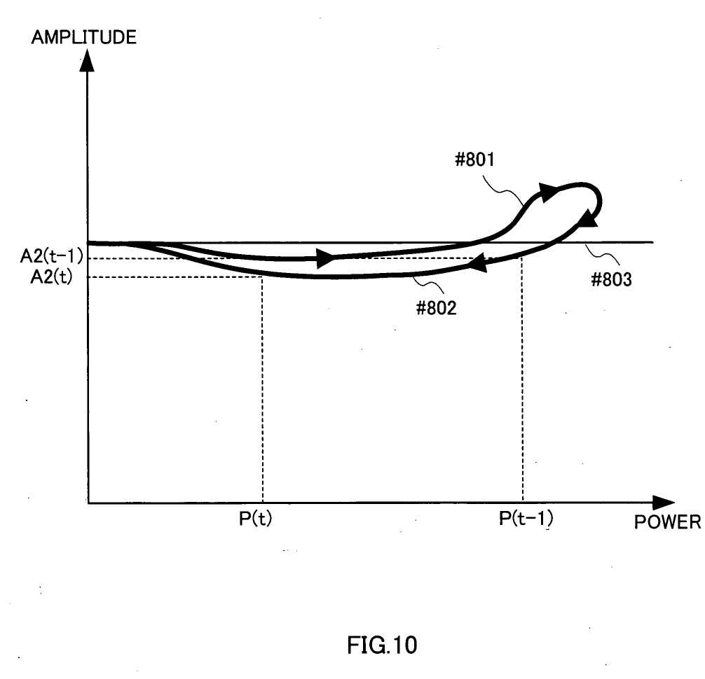

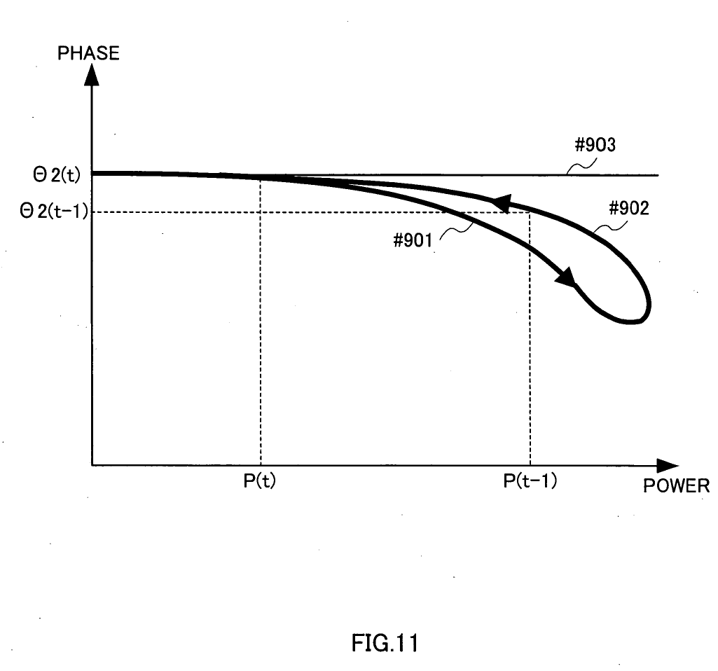

In this way, IM unbalance compensation computation section 306 converts the hysteresis characteristics shown in FIG. 6 and FIG. 7 to the compensation characteristics shown in FIG. 8 through FIG. 11. FIG. 8 and FIG. 10 are drawings showing the relationship between amplitude and power in compensation characteristics, and FIG. 9 and FIG. 11 are drawings showing the relationship between phase and power in compensation characteristics.

By converting an unbalance IM characteristic to a compensation characteristic, when input power is on an upward trend, relationship #601 between amplitude and power is converted to a relationship #801 between amplitude and power, and relationship #701 between phase and power is converted to a relationship #901 between phase and power. Also, by converting an unbalance IM characteristic to a compensation characteristic, when input power is on a downward trend, relationship #602 between amplitude and power is converted to a relationship #802 between amplitude and power, and relationship #702 between phase and power is converted to a relationship #902 between phase and power. IM unbalance compensation computation section 306 stores compensation characteristics by storing the relationships between amplitude and power and the relationships between phase and power shown in FIG. 8 through FIG. 11 in a data table as vector information.

That is to say, relationship #801 between amplitude and power and relationship #802 between amplitude and power are symmetrical with relationship #601 between amplitude and power and relationship #602 between amplitude and power with respect to a relationship #803 between amplitude and power in which amplitude becomes almost fixed when amplifier 312 is assumed to have a linear characteristic. Also, relationship #901 between phase and power and relationship #902 between phase and power are symmetrical with relationship #701 between phase and power and relationship #702 between phase and power with respect to a relationship #903 between phase and power in which phase becomes almost fixed when amplifier 312 is assumed to have a linear characteristic.

Then, if measured power P(t) at time t has risen above measured power P(t−1) at time t−1, IM unbalance compensation computation section 306 determines that measured power is on an upward trend, selects A1(t−1) as the amplitude component of measured power P(t−1) at time t−1 and selects A1(t) as the amplitude component of measured power P(t) at time t from FIG. 8, and also selects θ1(t−1) as the phase component of measured power P(t−1) at time t−1 and selects θ1(t) as the phase component of measured power P(t) at time t from FIG. 9. IM unbalance compensation computation section 306 then outputs a compensation signal that has compensation characteristics for the selected amplitude and phase components. The fixed value here is found from relationship #803 between amplitude and power in which amplitude becomes almost fixed as shown in FIG. 8 and relationship #903 between phase and power in which phase becomes almost fixed as shown in FIG. 9.

On the other hand, if measured power P(t) at time t has fallen below measured power P(t−1) at time t−1, IM unbalance compensation computation section 306 determines that measured power is on a downward trend, selects A2(t−1) as the amplitude component of measured power P(t−1) at time t−1 and selects A2(t) as the amplitude component of measured power P(t) at time t from FIG. 10, and also selects θ2(t−1) as the phase component of measured power P(t−1) at time t−1 and selects θ2(t) as the phase component of measured power P(t) at time t from FIG. 11. IM unbalance compensation computation section 306 then outputs a compensation signal that has compensation characteristics for the selected amplitude and phase components. The fixed value here is found in the same way as in the case of FIG. 8 and FIG. 9.

Next, complex multiplication section 307 suppresses distortion component #203 and distortion component #204 in FIG. 2 by combining the transmit signal and compensation signal.

Here, the data table stored by IM unbalance compensation computation section 306 is stored as vector information, and the vector information has amplitude information and phase information. Therefore, IM unbalance compensation computation section 306 has amplitude and phase components corresponding to power P input to amplifier 312 as a compensation data table. That is to say, the relationship between an input signal to amplifier 312 and an output signal from amplifier 312 is expressed as shown in Equation (4).
Output signal=amp×input signal (4)
where amp: Amplifier characteristic

Also, amplifier characteristic amp is expressed as shown in Equation (5).
amp(P)=A(P)×e^{-jθ(P)} (5)
where
A(P): Amplitude component
θ(P): Phase component
P: Power input to amplifier 312
amp(P): Amplifier characteristic

Therefore, the amplifier characteristic can be found as an amplitude component and phase component from Equation (5).

Thus, according to this embodiment, baseband signal distortion components are suppressed by finding a compensation signal that has an amplitude component and phase component that differ when measured power is on an upward trend and when measured power is on a downward trend, enabling distortion components in a state of lower/upper unbalance to be suppressed with high precision. Also, according to this embodiment, distortion components in a state of lower/upper unbalance can be suppressed by correcting linear characteristic information found by means of a compensation data table 304 identical to a conventional compensation data table 104 and a method identical to the conventional method, and a conventional apparatus need not be greatly changed, enabling an apparatus with good distortion suppression precision to be provided at low cost.

As described above, according to the present invention distortion components in a state of lower/upper unbalance can be suppressed with high precision.

This application is based on Japanese Patent Application No. 2002-365447 filed on Dec. 17, 2002, the entire content of which is expressly incorporated by reference herein.

### INDUSTRIAL APPLICABILITY

The present invention relates to a distortion compensation apparatus and distortion compensation method, and is suitable for use, for example, in a distortion compensation apparatus and distortion compensation method that eliminate distortion generated when a signal is amplified.

1. A distortion compensation apparatus comprising:
a power calculation section that measures baseband signal power at predetermined time intervals;
a compensation computation section that generates a compensation signal for suppressing distortion components of said baseband signal so that a first phase component and a first amplitude component when power is identical in said compensation signal differ when current power measured by said power calculation section is rising with respect to past power and when current power measured by said power calculation section is falling with respect to past power;
a compensation signal combining section that combines said compensation signal generated by said compensation computation section with said baseband signal; and
an amplification section that suppresses with said compensation signal said distortion components generated during amplification by amplifying said baseband signal with which said compensation signal is combined by said compensation signal combining section.

2. The distortion compensation apparatus according to claim 1, wherein said compensation computation section detects said distortion components that are nonlinear and for which a second amplitude component and a second phase component when power is identical in said distortion components differ when current power measured by said power calculation section is rising with respect to past power and when current power measured by said power calculation section is falling with respect to past power, and generates said compensation signal that has said first amplitude component and said first phase component that are symmetrical to said second amplitude component and said second phase component in detected said distortion components with respect to a fixed value of said second amplitude component and said second phase component when said distortion components have a linear characteristic.

3. A transmitting apparatus provided with a distortion compensation apparatus, said distortion compensation apparatus comprising:
a power calculation section that measures baseband signal power at predetermined time intervals;
a compensation computation section that generates a compensation signal for suppressing distortion components of said baseband signal so that a first phase component and a first amplitude component when power is identical in said compensation signal differ when current power measured by said power calculation section is rising with respect to past power and when current power measured by said power calculation section is falling with respect to past power;
a compensation signal combining section that combines said compensation signal generated by said compensation computation section with said baseband signal; and
an amplification section that suppresses with said compensation signal said distortion components generated during amplification by amplifying said baseband signal with which said compensation signal is combined by said compensation signal combining section.

4. A distortion compensation method comprising:
a step of measuring baseband signal power at predetermined time intervals;
a step of generating a compensation signal for suppressing distortion components of said baseband signal so that a first phase component and a first amplitude component when power is identical in said compensation signal differ when measured current power is rising with respect to past measured power and when measured current power is falling with respect to past measured power;
a step of combining generated said compensation signal with said baseband signal; and
a step of suppressing with said compensation signal said distortion components generated during amplification by amplifying said baseband signal with which said compensation signal is combined.
